(19) United States
(12) Patent Application Publication
(10) Pub. No.: US 2024/0391763 A1
(43) Pub. Date: Nov. 28, 2024

(54) A METHOD FOR PRODUCING SYNGAS USING CATALYTIC REVERSE WATER GAS SHIFT

(71) Applicant: SHELL USA, INC., Houston, TX (US)

(72) Inventors: Ronald Jan SCHOONEBEEK, Amsterdam (NL); Dominik Johannes Michael UNRUH, Amsterdam (NL); Alouisius Nicolaas Renée BOS, Amsterdam (NL)

(21) Appl. No.: 18/690,767

(22) PCT Filed: Sep. 7, 2022
(86) PCT No.: PCT/EP2022/074859

§ 371 Date: Mar. 11, 2024

(30) Foreign Application Priority Data
Sep. 14, 2021 (EP) 21196683.3

(51) Int. Cl. C01B 3/16

(52) U.S. Cl. CPC C01B 3/16; C01B 2203/0288; C01B 2203/0475; C01B 2203/0495; C01B 2203/0833; C01B 2203/0883; C01B 2203/1041

(57) ABSTRACT

A method for producing syngas is provided, which comprises providing a feed stream comprising H₂ and CO₂; heating the feed stream in a first heat exchanger to provide a first heated feed stream, which is introduced into a first RWGS reactor and subjected to a first catalytic RWGS reaction in the presence of a non-methanation promoting catalyst, thereby obtaining a first syngas containing stream, which is cooled in the first heat exchanger against the feed stream, thereby obtaining a first cooled syngas stream, which is separated in a first gas/liquid separator thereby obtaining a first water-enriched stream and a first water-depleted syngas stream; heating the first water-depleted syngas stream in a second heat exchanger thereby obtaining a heated first water-depleted syngas stream, which is introduced into a second RWGS reactor and subjected to a second catalytic RWGS reaction in the presence of a non-methanation promoting catalyst.

The present invention relates to a method for producing syngas using a catalytic reverse water gas shift (RWGS) reaction.

Methods for producing syngas using RWGS are known. RWGS reactions convert carbon dioxide (CO₂) and hydrogen (H₂) into ‘syngas’, which contains at least carbon monoxide (CO) and hydrogen (H₂), and typically also water (H₂O) and unconverted carbon dioxide (CO₂). RWGS reactions are endothermic in nature; hence, it is necessary to supply sufficient thermal energy to the reactants (i.e. carbon dioxide and hydrogen) to facilitate the endothermic RWGS reaction.

The RWGS reaction is in fact the backward reaction of the equilibrium of the ‘water gas shift’ (WGS) reaction, which is a well-known reaction to convert carbon monoxide and water to carbon dioxide and hydrogen. The RWGS reaction can proceed without the use of a catalyst, but this requires very high temperatures (e.g. 1000° C. or even much higher) favoring both the kinetics and maximum achievable equilibrium conversions.

If a catalyst for the RWGS reaction is used, much lower temperatures may be required for the reaction to proceed and the reaction conditions and catalyst used are to be selected such that the catalyzation of the very exothermic methanation reaction (CO₂+4H₂->CH₄+2H₂O) is avoided or at least minimized. The thermodynamics may drive the reaction towards methanation and too low temperatures may severely limit the equilibrium conversion RWGS itself, so finding reaction conditions and a catalyst resulting in acceptable conversion of CO₂ to syngas with non-methanation or very low methanation is a key challenge.

Currently, the status of developments regarding the RWGS reaction have been mostly on lab-scale. There is still a lot to explore until large-scale RWGS will be a commercially attractive option.

For large-scale conversion of carbon dioxide there is a need to be able to more efficiently and economically carry out the RWGS reaction. In achieving high conversion of carbon dioxide selectively to carbon monoxide, by-products like methane and carbon formation are to be avoided. Also, the amount of energy input required for performing the endothermic RWGS reaction requires attention.

As a mere example of a recently published RWGS method, WO2020114899A1 discloses a method for producing syngas using a RWGS reaction, wherein no catalyst is present in the reaction vessel and the temperature in the reaction vessel is maintained in the range of 1000 to 1500° C.

A problem of the above method is that relatively high temperatures are used to perform the RWGS reaction which requires the use of high temperature resistant materials in the reaction vessel, synthesis gas coolers or feed effluent heat exchangers.

Another problem of the above method is that a relatively high energy input is required to perform the (endothermic) RWGS reaction and to heat up the feed stream to the reaction temperature, i.e. achieving a high energy efficiency is a challenge.

WO2021062384A1 discloses a multi-stage catalytic RWGS method, wherein a fired-tubular RWGS reactor is used. A problem of the use of such fired-tubular RWGS reactors is the associated CO₂ production.

As another example of a RWGS method, WO2008115933A1 discloses a process for renewable hydrocarbons and oxygenates that combines two steps: (1) a Renewable CO Production (RCOP) step where a mixture of CO and H₂ is produced and (2) a Fischer-Tropsch synthesis section where (after further addition of hydrogen) the desired end products are made. The problem with this process is that the latter step is needed because this RWGS section in the RCOP step can only produce syngas with a hydrogen to CO ratio up to 1.4, otherwise there is excessive methanation. More commonly in their process the H₂/CO ratio is significantly below 1.0; nearly all examples disclosed in this prior art shows H₂/CO ratios below 0.7. Moreover, this process of the prior art teaches to apply pressures preferably below 10 bar pressure and temperatures below 450° C. to suppress methanation. Hence the RWGS reactor in this prior art process operates at relatively unfavorable conditions, allowing for only low conversions per pass. Consequently, the overall process of WO2008115933A1 is rather complex and capital intensive.

In contrast, it is one of the advantages of the present invention to allow operating at more elevated pressures and temperatures and to produce a syngas with a H₂/CO ratio around 2.0, with less than 1% methane, so it can be directly used as feed for a conventional Fischer-Tropsch process, or even relatively higher so it can be directly used for methanol synthesis.

As another example of a RWGS method, WO2007108014A1 discloses a process for producing liquid hydrocarbon products from H₂ and CO₂ including a generic RWGS step. However, this prior art does not teach or disclose any details or advantages of the RWGS step.

As another example of a RWGS process, WO2021062384A1 discloses a process for producing liquid hydrocarbon products from H₂ and CO₂ including a RWGS step with two (or more) reactors in series. Notably, the last of the reactors in series is “fired”, i.e. the heat is provided via burning of a fuel on the outside of tubes filled with catalyst. In case a hydrocarbon is used as fuel, the CO₂ produced and present in the exhaust is recycled to the RWGS reactors.

In contrast, it is one of the advantages of the present invention to allow operating at relatively lower temperatures, allowing for high efficiencies whilst preventing high skin temperatures present in fired reactors.

It is an object of the present invention to minimize one or more of the above problems.

It is a further object of the present invention to provide a method for producing syngas using a RWGS reaction that can be performed at lower temperatures, preferably lower than 600° C.

One or more of the above or other objects can be achieved by providing a method for producing syngas using a catalytic reverse water gas shift (RWGS) reaction, the method at least comprising the steps of:
a) providing a feed stream comprising at least hydrogen (H₂) and carbon dioxide (CO₂);
b) heating the feed stream provided in step a) in a first heat exchanger thereby obtaining a first heated feed stream;
c) introducing the first heated feed stream into a first RWGS reactor and subjecting it to a first catalytic RWGS reaction, thereby obtaining a first syngas containing stream;
d) cooling the first syngas containing stream obtained in step c) in the first heat exchanger against the feed stream provided in step a), thereby obtaining a first cooled syngas stream;
e) separating the first cooled syngas stream obtained in step d) in a first gas/liquid separator thereby obtaining a first water-enriched stream and a first water-depleted syngas stream;
f) heating the first water-depleted syngas stream obtained in step e) in a second heat exchanger thereby obtaining a heated first water-depleted syngas stream;
g) introducing the heated first water-depleted syngas stream obtained in step f) into a second RWGS reactor and subjecting it to a second catalytic RWGS reaction, thereby obtaining a second syngas containing stream;
h) cooling the second syngas containing stream obtained in step g) in the second heat exchanger against the first water-depleted syngas stream obtained in step e), thereby obtaining a second cooled syngas stream;
i) separating the second cooled syngas stream obtained in step h) in a second gas/liquid separator thereby obtaining a second water-enriched stream and a second water-depleted syngas stream;
j) separating the second water-depleted syngas stream obtained in step i) in a CO₂ removal unit thereby obtaining a CO₂-enriched stream and a CO₂-depleted syngas stream;
k) combining the CO₂-enriched stream obtained in step j) with the feed stream provided in step a) and/or the first water-depleted syngas stream obtained in step e);
   wherein the temperature of the first syngas containing stream obtained in step c) and the second syngas containing stream obtained in step g) is kept below 600° C., preferably below 550° C.; and
   wherein the first and the second RWGS reactors each comprise a multi-tubular reactor heated by molten salt circulating around the tubes of the multi-tubular reactor. This circulating molten salt supplies the heat for the endothermic RWGS reaction taking place inside the tubes of the multi-tubular reactor. The circulating molten salt itself is typically heated outside the reactor, e.g. by means of an e-heater.

It has surprisingly been found according to the present invention that even though the RWGS reaction is performed at relatively low temperatures (such as below 600° C.), a desirable total conversion per pass of CO₂ (whilst comparing the CO₂ content of the feed stream of step b) with the CO₂ content of the second syngas containing stream as obtained in step g), i.e. prior to removing the CO₂ of that stream in the CO₂ removal unit in step j)) of above 55% or even above 70% may be achieved at temperatures below 600° C., whilst minimizing carbon formation and/or methanation (methane formation) even though the latter two are thermodynamically favoured.

An important advantage of the present invention is that less expensive materials need to be used for e.g. the reactors, heaters and heat exchangers in view of the lower temperatures being used, which alleviates materials problems related to the nature of the gas stream (e.g. metal dusting, methanation, etc.).

Also, commercially available heated reactors using molten salt or multi-tubular molten salt reactors can be used for the heating required in the endothermic RWGS reaction.

A further advantage of the present invention is that it allows for flexibility in the CO/H₂ ratio of the obtained syngas product stream. Dependent on the use of the syngas product stream (such as production of methanol or DME (dimethyl ether), use in Fischer-Tropsch reaction, etc.), the CO/H₂ ratio can be easily adapted, by just changing the inlet feed ratio of CO₂/H₂ to the first RWGS reactor.

In step a) of the method according to the present invention a feed stream is provided comprising at least hydrogen (H₂) and carbon dioxide (CO₂).

The person skilled in the art will readily understand that the feed stream is not particularly limited and may come from various sources. Typically, the feed stream comprises 60-80 vol. % H₂, preferably 65-75 vol. % H₂, and typically 20-40 vol. % CO₂, preferably 25-35 vol. % CO₂. Other components such as H₂, CH₄, CO, H₂O, C2+, C=2+, Ar, O₂, sulphur components (H₂S, mercaptans, COS, SO₂) and nitrogen components (NH₃, NOx, N₂) may be present.

Generally, the feed stream has a hydrogen to carbon dioxide (H₂/CO₂) volume ratio of from 1 to 5, preferably between 2 and 3.5. The H₂/CO₂ volume ratio of hydrogen to carbon dioxide can be adjusted such that the required hydrogen to carbon monoxide ratio in the eventual product stream is obtained. Further, please note that the H₂/CO₂ volume ratio of the feed stream may subsequently be lowered by the combination of the feed stream provided in step a) with the CO₂-enriched stream obtained in step j).

Generally, the feed stream has a temperature of 5-150° C. and, preferably above 20° C. The feed stream typically has a pressure in the range of from 0.5 to 200 bara. Preferably, the pressure is from 5 to 70 bara.

In step b) of the method according to the present invention, the feed stream provided in step a) is heated (by indirect heat exchange) in a first heat exchanger thereby obtaining a first heated feed stream.

Preferably, the feed stream to be heated in the first heat exchanger is a combined stream, viz. the combination (as occurring in step k)) of the CO₂-enriched stream obtained in step j) with the feed stream provided in step a).

Typically, the first heated feed stream has a temperature of 200-600° C., preferably 450-550° C. The person skilled in the art will readily understand that in addition to the first heat exchanger, further heat exchangers may be present; such further heat exchangers may form part of the overhead of the first RWGS reactor.

Preferably, the first heated feed stream (20) has a hydrogen to carbon dioxide (H₂/CO₂) volume ratio of between 1.2 and 3.0, preferably above 1.5, more preferably above 1.6 and preferably below 2.0.

Please note in this respect that the H₂/CO₂ volume ratio of the first heated stream may be lower than the H₂/CO₂ volume ratio of the feed stream, in view of the potential combination of the feed stream provided in step a) with the CO₂-enriched stream obtained in step j). This combination of the feed stream provided in step a) with the CO₂-enriched stream obtained in step j) occurs before the heating in step b).

In step c) of the method according to the present invention, the first heated feed stream is introduced into a first RWGS reactor and subjected to a first catalytic RWGS reaction, thereby obtaining a first syngas containing stream.

As the person skilled in the art is familiar with RWGS reactors and conditions of catalytic RWGS reactions, this is not discussed here in detail.

For the suitable ‘non-methanation promoting’ catalysts as described below, typical temperatures of the catalytic RWGS reaction in the first RWGS reactor are 450-600° C., preferably above 500° C. The person skilled in the art will understand that the temperature may vary over the reactor length (e.g. lower near the reactor inlet of a molten slat heated multi-tubular reactor and higher near the outlet, i.e. close to the temperature of the molten salt). According to the present invention, the temperature of the first catalytic RWGS reaction in step c) is kept below 600° C., preferably below 550° C.

As, the RWGS reaction is endothermic, heating needs to be provided to the reactor. This heating may come from any source, preferably indirectly via heating by heated molten salt circulating around the individual tubes of a multi-tubular reactor, preferably in counter-current mode, or directly via heating the feed stream in the case of an adiabatic process. It is especially preferred that the circulating molten salt itself is heated by electrical heating thereby avoiding the use of fired reactors. It is even more preferred that the electrical heating has a renewable source. Also, it is preferred that no use is made of fired reactors (as is proposed in WO2021062384A1).

Typical pressures as used in the first (and other) RWGS reactor(s) are 1-200 bara, preferably 20-60 bara. Further, typical gas hourly space velocities (GHSV in unit volume of total feed gas at standard conditions per unit volume of catalyst bed) are 1000-100,000 h⁻¹, preferably above 3,000 h⁻¹ and preferably below 15,000 h⁻¹.

In the first RWGS reactor a catalytic RWGS reaction takes place and this requires the presence of a catalyst. Typically, the first RWGS reactor contains a catalyst bed. As the person skilled in the art is familiar with suitable RWGS beds and catalysts, this is not discussed here in detail. Preferably, the catalyst bed comprises a catalyst that is suitable for performing a RWGS reaction below 600° C. Further it is preferred that the catalyst does not promote methanation under the used conditions. Preferred examples of suitable ‘non-methanation promoting’ catalysts comprise at least cerium oxide, zirconium oxide, or a combination thereof. The catalyst may contain further components in addition to the cerium oxide and/or zirconium oxide.

According to the present invention each of the first and the second RWGS reactors comprises a multi-tubular reactor (in which the catalyst bed is placed) heated by molten salt circulating around the tubes of the multi-tubular reactor. In this embodiment, the molten salt provides for the heat required for the endothermic reaction as taking place in the multi-tubular reactor. Preferably, the molten salt is circulating in counter-current mode around the tubes of the multi-tubular reactor (when compared to the fluid flow in the tubes of the reactor). The circulating molten salt is preferably heated from outside the reactor. Preferably, each of the tubes of the multi-tubular reactor comprises a ‘non-methanation promoting’ catalyst, comprising at least cerium oxide, zirconium oxide, or a combination thereof.

Preferably, the molten salt used for heating the multi-tubular reactors of the first and the second RWGS reactors is coming from a shared molten salt circulation system. In this way, the same molten salt circulates through the multi-tubular reactors of both the first and the second RWGS reactors.

As a result of the first RWGS reaction in step c), a first syngas containing stream is obtained, at least comprising hydrogen (H₂) and carbon monoxide (CO). Typically, the first syngas containing stream also contains water (H₂O) and unconverted carbon dioxide (CO₂). Typically, the amounts of components in the first syngas containing stream are around thermodynamic equilibrium concentrations (without taking the methanation reaction into account in the equilibrium calculations because otherwise such calculations would predict the generation of a lot of methane, whereas the preferred ‘non-methanation promoting catalysts’ prevent significant methanation).

Generally, the first syngas containing stream has a hydrogen to carbon monoxide (H₂/CO) volume ratio in the range of 0.5 to 5, preferably in the range of 1.5 to 3.

One of the advantages of the present invention is that the used RWGS reaction results in low methanation (methane formation). Preferably, the first syngas containing stream comprises at most 1.0 vol. % methane (CH₄), preferably at most 0.1 vol. % methane, even more preferably at most 0.01 vol. % methane.

In step d) of the method according to the present invention, the first syngas containing stream obtained in step c) is cooled in the first heat exchanger against the feed stream provided in step a), thereby obtaining a first cooled syngas stream.

Typically, the first cooled syngas stream has a temperature of 80-250° C. and, preferably below 200° C.

In step e) of the method according to the present invention, the first cooled syngas stream obtained in step e) is separated in a first gas/liquid separator thereby obtaining a water-enriched stream and a first water-depleted syngas stream. Typically, the water-enriched stream and the first water-depleted syngas stream have a temperature in the range of from 20 to 80° C.

Typically, the amounts of components in the first water-depleted syngas stream are around thermodynamic equilibrium concentrations. Please note that a small amount of water (e.g. about 1%) may be left in on purpose to avoid materials issues.

In step f) of the method according to the present invention, the first water-depleted syngas stream obtained in step e) is heated in a second heat exchanger thereby obtaining a heated first water-depleted syngas stream.

The person skilled in the art will understand that further heat exchangers may be present. These further heat exchangers may also be part of the RWGS reactor. Also, these further heat exchangers may be heated by electrical heating.

Typically, the heated first water-depleted syngas stream has a temperature of 450-600° C. and, preferably 500-550° C.

In step g) of the method according to the present invention, the heated first water-depleted syngas stream obtained in step f) is introduced into a second RWGS reactor and is subjected to a second catalytic RWGS reaction, thereby obtaining a second syngas containing stream.

Typically, the temperatures and other conditions of the second RWGS reactor will typically be the same as, or similar to, the temperatures and other conditions of the first RWGS reaction as described above.

Preferably, the temperature of the second syngas containing stream is at most 20° C. higher than the temperature of the first syngas containing stream, preferably at most 10° C. higher, more preferably at most 5° C. higher, even more preferably not higher than the temperature of the first syngas containing stream. By keeping the temperature in the RWGS reactors relatively low, materials issues are avoided or at least minimized.

Generally, the heated first water-depleted syngas stream introduced into the second RWGS reactor has a hydrogen to carbon dioxide (H₂/CO₂) volume ratio of from 1 to 5, preferably between 2 and 3.5. The H₂/CO₂ volume ratio of hydrogen to carbon dioxide is adjusted such that the required hydrogen to carbon monoxide ratio in the eventual product stream is obtained. Preferably, the heated first water-depleted syngas stream obtained in step f) has a hydrogen to carbon dioxide (H₂/CO₂) volume ratio in the range of from 1.5 to 3.5, more preferably from 1.8 to 2.5.

As mentioned above, the temperatures and other conditions of the second RWGS reactor will typically be the same as, or similar to, the temperatures and other conditions of the first RWGS reactor as described above. Hence, typical temperatures of the catalytic RWGS reaction in the first RWGS reactor are 450-600° C., preferably above 500° C. Preferably, the temperature of the second catalytic RWGS reaction in step c) is kept below 600° C., preferably below 550° C.

Similar to the first RWGS reactor, the second RWGS reactor also typically contains a catalyst bed. It is also preferred that the catalyst bed comprises a catalyst that is suitable for performing a RWGS reaction below 600° C.

The second RWGS reactor may contains two or more catalyst beds with additional intermediate heating between the two or more catalyst beds.

As a result of the second RWGS reaction in step h), a second syngas containing stream is obtained, at least comprising hydrogen (H₂) and carbon monoxide (CO). Typically, the second syngas containing stream also contains water (H₂O) and unconverted carbon dioxide (CO₂). Typically, the amounts of components in the second syngas containing stream are around thermodynamic equilibrium concentrations.

Generally, the second syngas containing stream has a hydrogen to carbon monoxide (H₂/CO) volume ratio in the range of 1.5 to 5, preferably in the range of 1.8 to 2.5.

One of the advantages of the present invention is that the used RWGS method results in low methanation (methane formation). Preferably, the second syngas containing stream comprises at most 1.0 vol. % methane (CH₄), preferably at most 0.2 vol. % methane.

In step h) of the method according to the present invention, the second syngas containing stream obtained in step g) is cooled in the second heat exchanger against the first water-depleted syngas stream obtained in step e), thereby obtaining a second cooled syngas stream.

Typically, the second cooled syngas stream has a temperature of 80-250° C. and, preferably 100-200° C. This stream may be further cooled to ambient.

In step i) of the second cooled syngas stream is separated in a second gas/liquid separator, thereby obtaining a second water-enriched stream and a second water-depleted syngas stream.

In step j) of the method according to the present invention, the second water-depleted syngas stream obtained in step i) is separated in a CO₂ removal unit thereby obtaining a CO₂-enriched stream and a CO₂-depleted syngas stream. As the person skilled in the art is familiar with CO₂ removal units, this is not further discussed here in detail.

The CO₂-enriched stream obtained in step j) comprises at least 90 vol. % CO₂, preferably at least 95 vol. % CO₂, more preferably at least 99 vol. % CO₂. The CO₂-enriched stream typically also contains some minor amounts of H₂, CO and H₂O.

In step k) of the method according to the present invention, the CO₂-enriched stream obtained in step j) is combined with the feed stream provided in step a) and/or the first water-depleted syngas stream obtained in step e).

It is especially preferred according to the present invention that at least a part of the CO₂-enriched stream obtained in step j) is combined with at least the feed stream provided in step a). In this case, the feed stream to be heated in step b) in the first heat exchanger is preferably a combined stream, viz. the combination (as occurring in step k)) of (at least a part of) the CO₂-enriched stream obtained in step j) with the feed stream provided in step a). Preferably, the full CO₂-enriched stream obtained in step j) is combined with the feed stream provided in step a).

Further it is preferred that the CO₂-depleted syngas stream obtained in step j) comprises at most 10 vol. % CO₂, preferably at most 5 vol. % CO₂, more preferably at most 2 vol. % CO₂.

Furthermore, it is preferred that the CO₂-depleted syngas stream obtained in step j) has a hydrogen to carbon monoxide (H₂/CO) volume ratio in the range of from 1.5 to 2.5. The latter range makes this stream very suitable as a syngas stream for e.g. production of methanol or DME (dimethyl ether), or for use in Fischer-Tropsch reactions.

The person skilled in the art will understand that the method according to the present invention may comprise further processing steps, including third and further RWGS reactors and g/l separators. The temperatures and other conditions of the further RWGS reactors will typically be the same as, or similar to, the temperatures and other conditions of the first and second RWGS reactors as described above. Preferably, the temperature of the further RWGS reactors is kept below 600° C., preferably below 550° C.

In a further aspect, the present invention provides an apparatus suitable for performing the method for producing syngas according to the present invention, the apparatus at least comprising:
a first heat exchanger for heat exchanging the feed stream against the first syngas containing stream obtained in the first RWGS reactor, to obtain a first heated feed stream and a first cooled syngas stream;
a first RWGS reactor for subjecting the first heated feed stream to a catalytic RWGS reaction to obtain a first syngas containing stream;
a first gas/liquid separator for separating the first cooled syngas stream to obtain a first water-enriched stream and a first water-depleted syngas stream;
a second heat exchanger for heat exchanging the first water-depleted syngas and the second syngas containing stream obtained in the second RWGS reactor, to obtain a heated first water-depleted syngas stream and a second cooled syngas product stream;
a second RWGS reactor for subjecting the heated first water-depleted syngas stream to a catalytic RWGS reaction to obtain a second syngas containing stream;
a second gas/liquid separator for separating the second cooled syngas stream to obtain a second water-enriched stream and a second water-depleted syngas stream;
a CO₂ removal unit for separating the second water-depleted syngas stream to obtain a CO₂-enriched stream and a CO₂-depleted syngas stream;
   wherein the apparatus is configured to combine the CO₂-enriched stream obtained in the CO₂ removal unit with the feed stream and/or the first water-depleted syngas stream; and
   wherein the first and the second RWGS reactors each comprise a multi-tubular reactor that can be heated by molten salt circulating around the tubes of the multi-tubular reactor.

Preferably, the apparatus according to the present invention further comprises a molten salt circulation system for heating the multi-tubular reactors of both the first and the second RWGS reactors. In this way, the molten salt circulation system is a ‘shared system’ in the sense that the same molten salt flows around the tubes of the multi-tubular reactors of both the first and second RWGS reactors.

Hereinafter the present invention will be further illustrated by the following non-limiting drawings.

Herein shows:

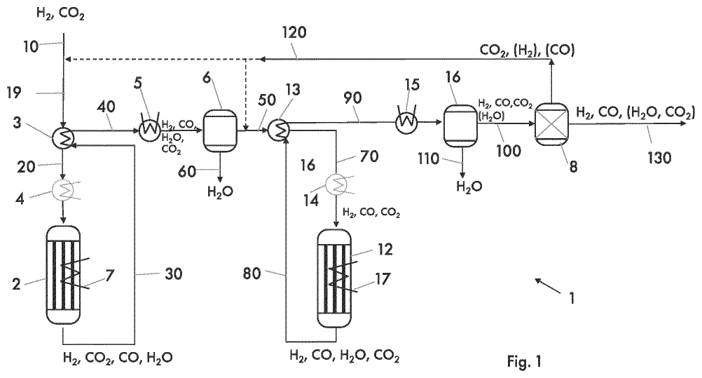

FIG. 1 schematically an embodiment of a process line-up suitable for performing the method for producing syngas using a catalytic RWGS reaction according to the present invention;

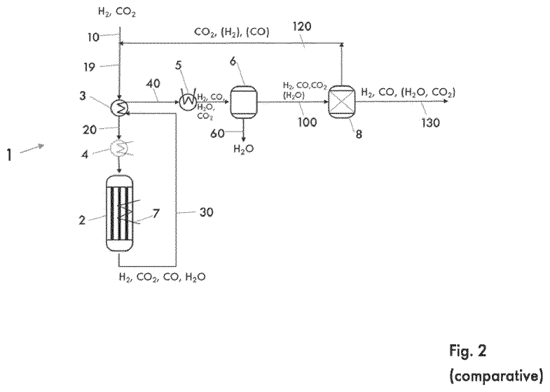

FIG. 2 schematically a first comparative line-up (not according to the present invention), wherein the line-up also has a CO₂-recycle but (different to the present invention) only one RWGS reactor; and

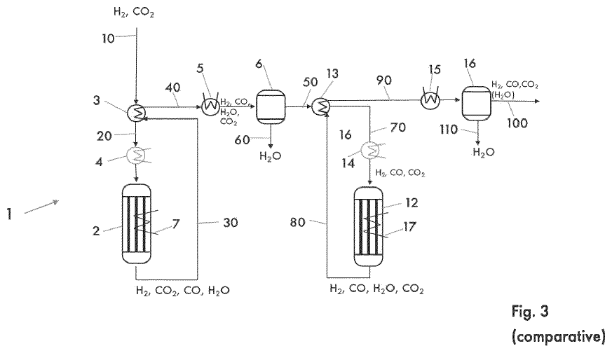

FIG. 3 schematically a second comparative line-up (not according to the present invention), wherein the line-up has two RWGS reactors but (different to the present invention) no CO₂-recycle.

For the purpose of this description, same reference numbers refer to same or similar components.

The process line-up (or apparatus) of FIG. 1, generally referred to with reference number 1, comprises a first RWGS reactor 2 and a second RWGS reactor 12; a first heat exchanger 3, a second heat exchanger 13 and further heat exchangers 4, 5, 14 and 15; a first gas/liquid separator 6 and a second gas/liquid separator 16; and a CO₂ removal unit 8.

Each of the RWGS reactors 2 and 12 comprise a catalyst bed and is provided with external heating 7, 17, 27 (heated by a molten salt heater). The catalyst bed comprises a non-methanation promoting catalyst (such as cerium oxide, zirconium oxide, or a combination thereof).

During use, a feed stream 10 is provided, which feed stream comprises at least hydrogen (H₂) and carbon dioxide (CO₂).

The feed stream is heated in the first heat exchanger 3 thereby obtaining a first heated feed stream 20. As shown in the embodiment of FIG. 1, the heated feed stream 20 may be further heated in a further heat exchanger 4. This further heat exchanger 4 may form part of the first RWGS reactor 2.

The first heated feed stream 20 is introduced into the first RWGS reactor 2 and subjected to a first catalytic RWGS reaction, thereby obtaining a first syngas containing stream, which is removed as stream 30 from the first RWGS reactor 2.

Then, the first syngas containing stream 30 is cooled in the first heat exchanger 3 by indirect heat exchange against the feed stream 10, thereby obtaining a first cooled syngas stream 40. As shown in the embodiment of FIG. 1, the cooled syngas stream 40 may be further cooled in the further heat exchanger 5.

Subsequently, the first cooled syngas stream 40 is separated in the first gas/liquid separator 6 thereby obtaining a first water-enriched stream 60 and a first water-depleted syngas stream 50.

The first water-depleted syngas stream 50 is then heated in the second heat exchanger 13 thereby obtaining a heated first water-depleted syngas stream 70. This heated first water-depleted syngas stream 70 is then introduced into the second RWGS reactor 12 and subjected to a second catalytic RWGS reaction, thereby obtaining a second syngas containing stream which is removed from the second RWGS reactor 12 as stream 80.

This second syngas containing stream 80 is cooled in the second heat exchanger 13 by indirect heat exchange against the water-depleted syngas stream 50, thereby obtaining a second cooled syngas stream 90.

This second cooled syngas stream 90 is (in the embodiment of FIG. 1 after heat exchanging in further heat exchanger 15) subjected to separating in second gas/liquid separator 16 thereby obtaining a second water-enriched stream 110 and a second water-depleted syngas stream 100. This second water-depleted syngas stream 100 is separated in the CO₂ removal unit 8 thereby obtaining a CO₂-enriched stream 120 and a CO₂-depleted syngas stream 130.

As can be seen in the embodiment of FIG. 1, the CO₂-enriched stream 120 is combined (in part) with the feed stream 10 and (in part) with the first water-depleted syngas stream 50. Although the CO₂-enriched stream 120 may according to the present invention is combined with only the first water-depleted syngas stream 50, it is preferred that the combination of the CO₂-enriched stream 120 with the feed stream 10 is always present (the combination with the first water-depleted syngas stream 50 being optional). For sake of clarity, the ‘combined’ stream (of the CO₂-enriched stream 120 with the feed stream 10) is referred to with stream 19.

According to the present invention, the first and the second RWGS reactors 2,3 each comprise a multi-tubular reactor (shown in FIG. 2) that can be heated by molten salt circulating around the tubes of the multi-tubular reactor.

Preferably, the apparatus 1 comprises a molten salt circulation system (not shown) for heating the multi-tubular reactors of both the first and the second RWGS reactors 2,3. In this way, the molten salt circulation system is a ‘shared system’ in the sense that the same molten salt flows around the tubes of the multi-tubular reactors of both the first and second RWGS reactors 2,3. Preferably, the molten salt flow inside the shell of the multi-tubular reactor is counter-currently when compared to the flow of the gas inside the tubes. As shown, the molten salt may be heated by separate external heating, preferably an e-heater. Preferably, there is a common circuit for the molten salt for the two (or more) RWGS reactors.

The heat exchangers 4 and 14 may be integrated with each other.

FIG. 2 shows schematically a first comparative line-up (not according to the present invention), wherein the line-up also has a CO₂-recycle but (different to the present invention) only one RWGS reactor.

FIG. 3 shows schematically a second comparative line-up (not according to the present invention), wherein the line-up has two RWGS reactors but (different to the present invention) no CO₂-recycle.

### EXAMPLES

### Example 1. Recycle of Stream 120 Only to Stream 10

The apparatus of FIG. 1 with recycle of the CO₂ enriched stream 120 to only the feed stream 10 (and not to the first water-depleted syngas stream 50) was used for illustrating an exemplary method according to the present invention. The compositions and conditions of the streams in the various flow lines are provided in Table 1 below.

The values in Table 1 were calculated using a model generated with commercially available UniSim software, whilst using an ‘equilibrium reactor’ with settings such that only the (R)WGS reactions are allowed to occur and whilst arranging the settings such that no methanation occurred (hence 0 vol % CH₄ in all streams). Thus, the standard ‘Gibbs model’ was not used, which model would predict excess methanation (which does not occur or is at least minimized according to the present invention). Further, for the CO₂ removal unit 8 a CO₂ removal efficiency of 98% was assumed (this value of 98% is realistic; there are CO₂ removal units that come close to an efficiency of 100%).

As can be seen from Table 1 below, an overall CO₂ conversion of 98.9% was achieved, whilst aiming for a H₂/CO ratio of 1.9, which ratio is e.g. suitable for subsequent Fischer-Tropsch reaction.

TABLE 1
Recycle of stream 120 to only stream 10.

| stream | 10 | 19 | 30 | 50 | 60 | 80 | 100 | 110 | 120 | 130 |
|---|---|---|---|---|---|---|---|---|---|---|
| T [° C.] | 20 | 20 | 550 | 40 | 40 | 550 | 40 | 40 | 40 | 40 |
| CO₂ [vol. %] | 26 | 35 | 19 | 23 | <1 | 15 | 16 | <1 | >99 | <1 |
| H₂ [vol. %] | 74 | 65 | 48 | 58 | <1 | 50 | 54 | <1 | <1 | 64 |
| CO [vol. %] | 0 | <1 | 16 | 19 | <1 | 27 | 29 | <1 | <1 | 35 |
| H₂O [vol. %] | 0 | <1 | 16 | <1 | >99 | 8 | <1 | >99 | <1 | <1 |
| H₂/CO₂ | 2.8 | 1.8 | 2.5 | 2.5 | — | 3.3 | 3.3 | — | — | — |
| [mol/mol] | | | | | | | | | | |
| H₂/CO | — | — | 3.0 | 3.0 | — | 1.8 | 1.8 | — | — | 1.8 |
| [mol/mol] | | | | | | | | | | |
| XCO₂¹[%] | — | — | 46.1 | — | — | 64.3 | — | — | — | 98.9 |

¹XCO₂ = % overall conversion of CO₂, based on feed stream 10 and product stream 130.

### Example 2 Comparative—One RWGS Reactor with CO₂ Recycle

For comparison with Example 1 according to the present invention, a further set of calculations (whilst using the same UniSim software as used in Example 1) was performed for the line-up of FIG. 2, i.e. with still a CO₂-recycle but only one RWGS reactor. The compositions and conditions of the streams in the various flow lines are provided in Table 2 below.

Please note that the temperature, pressure and feed streams and resulting H₂/CO ratios were kept essentially the same; hence the difference between Example 1 and 2 is the number of RWGS stages (two for Example 1 according to the present invention and one for the comparative Example 2).

TABLE 2
Comparative. Single-stage RWGS with recycle of stream 120.

| stream | 10 | 19 | 30 | 60 | 100 | 120 | 130 |
|---|---|---|---|---|---|---|---|
| T [° C.] | 20 | 20 | 550 | 40 | 40 | 40 | 40 |
| CO₂ [vol. %] | 26 | 49 | 32 | <1 | 38 | >99 | <1 |
| H₂ [vol. %] | 74 | 51 | 33 | <1 | 40 | 0 | 65 |
| CO [vol. %] | 0 | <1 | 18 | <1 | 21 | 0 | 34 |
| H₂O [vol. %] | 0 | <1 | 18 | >99 | 0 | 0 | 0 |
| H₂/CO₂ | 2.8 | 1.0 | 1.1 | — | 1.1 | — | — |
| [mol/mol] | | | | | | | |
| H₂/CO | — | — | 1.9 | — | 1.9 | — | 1.9 |
| [mol/mol] | | | | | | | |
| XCO₂¹[%] | — | — | 35.6 | — | — | — | 96.5 |

¹XCO₂ = % overall conversion of CO₂, based on feed stream 10 and product stream 130.

To further explain the benefits of the present invention, the single-stage RWGS of (comparative) Example 2 versus two-stage RWGS line-up according to the present invention was compared in terms of the effects of reactor temperature (Table 3) and CO₂ conversion levels (Table 4) whilst the same composition of the feed streams was used.

Further, a comparison was made (see Table 5) showing the effect of the CO₂ recycle on the overall CO₂ conversion for a two-stage RWGS system.

Table 3 shows that according to the present invention (using two-stage RWGS) the CO₂ recycle flow rate can be reduced by a factor 3 compared to a single-stage RWGS system (also using a CO₂ recycle). This implies that also the whole separation section and recycle compressor—and associated costs—can be reduced by roughly a similar factor 3.

With ‘per pass CO₂ conversion’ is meant the CO₂ conversion based on the CO₂ mass flow rate in the inlet to the first RWGS reactor, i.e. stream 20, and CO₂ mass flow rate in the outlet of the last reactor, i.e. stream 80 for the two-stage system and stream 30 for the single stage.

TABLE 3
Per pass CO₂ conversions - comparison at 3 different temperatures.

| | T of the reactors (single and two stage) [° C.] | | |
|---|---|---|---|
| | 520 | 550 | 590 |
| Per pass CO₂ conversion | 31 | 36 | 41 |
| [%] single stage | | | |
| (comparative Example 2) | | | |
| Per pass CO₂ conversion | 59 | 64 | 71 |
| [%] two stage | | | |
| (Example 1) | | | |
| Relative increase in per | 88 | 80 | 72 |
| pass CO₂ conversion [%] | | | |
| Overall CO₂ conversion | 99 | 99 | 99 |
| CO₂-recycle flow vs CO₂ | 2.1 | 1.7 | 1.4 |
| feed flow single stage | | | |
| CO₂-recycle flow vs CO₂ | 0.7 | 0.5 | 0.4 |
| feed flow two stage | | | |
| [kg/kg] | | | |
| Relative CO₂ recycle | 67 | 68 | 70 |
| decrease | | | |

Table 3 shows that for the comparative embodiment using single RWGS stage with recycle (see FIG. 2) the per pass CO₂ conversions are only 31, 36 and 41% for the temperatures 520° C., 550° C. and 590° C. For Example 1 according to the present invention these per pass CO₂ conversions at the same temperatures are respectively 59, 64 and 71%. This represents a relative increase between 72-88%.

Table 4 below shows that to achieve the same per pass CO₂ conversions in a single stage as for the line-up of FIG. 1, the temperatures required would need to be in the range of 745-900° C. In this respect it is noted that temperatures above 600° C. result in severe material challenges. Hence the present invention allows for achieving the same high conversion at 225-310° C. lower than for a single stage RWGS system.

TABLE 4
Comparison single versus two-stage for
three per pass CO₂ conversion levels.

| | T reactor two stage [° C.] | | |
|---|---|---|---|
| | 520 | 550 | 590 |
| CO₂ conversion per pass [%] | 59 | 64 | 71 |
| T reactor needed to reach | 745 | 800 | 900 |
| same conversion per pass | | | |
| for single stage [° C.] | | | |

### Example 3 Comparative—Two-Stage RWGS without CO₂ Recycle

For yet another comparison with Example 1 according to the present invention, a further set of calculations (whilst using the same UniSim software as used in Example 1) was performed for the line-up of FIG. 3, i.e. with two RWGS reactor stages, but without a CO₂ recycle. Again the conditions were kept essentially the same as in Example 1.

Table 5 below compares the effect of the use of the CO₂ recycle stream (120 in FIG. 1; recycled to stream 10 thereby obtaining stream 19) on the total CO₂ conversion of a two-stage RWGS system.

As can be seen from Table 5, Comparative A (2-stage RWGS but no CO₂ recycle as in FIG. 3) shows that even for a two stage RWGS system (but no CO₂ recycle) the overall CO₂ conversion at 550° C. is only 74% compared to close to 99% for the present invention (Example 1, having two-stage RWGS with CO₂ recycle).

As Comparative B shows, to achieve the same overall CO₂ conversion in a two-stage RWGS system without CO₂ recycle, the temperatures required would need to be above 1000° C. because even at 1000° C. the achievable CO₂ conversion in a 2-stage RWGS system without CO₂ recycle is only 95% versus 99% for Example 1 at a temperature of only 550° C. Please note in this respect that temperatures above 600° C. already result in severe material challenges, and temperatures above 1000° C. are prohibitive for conventional reactor technologies.

TABLE 5
Effect of the use of the CO₂ recycle stream (120 in FIG.
1) on the total CO₂ conversion of a two-stage RWGS system

T of two-stage RWGS reactors [° C.]

| | 550 | 550 | 1000 |
|---|---|---|---|
| | (Example 1, | (Comparative | (Comparative |
| | with CO₂ | A, no CO₂ | B, no CO₂ |
| | recycle) | recycle) | recycle) |
| Overall CO₂ | 98.9 | 74.2 | 95.4 |
| conversion | | | |
| [%] | | | |
| Feed H₂/CO₂ | 2.8 | 2.8 | 2.8 |
| ratio | | | |
| (stream 10) | | | |
| [mol/mol] | | | |
| Syngas | 1.8 | 2.8 | 1.9 |
| H₂/CO ratio | | | |
| (stream 100) | | | |
| [mol/mol] | | | |

### DISCUSSION

As can be seen from the above Examples, the method according to the present invention allows for an effective way of producing syngas using a catalytic RWGS reaction, whilst maintaining the temperature in the RWGS reactors below 600° C. and whilst still achieving desirable per pass CO₂ conversions (per pass CO₂ conversion in the range of 59-71), and hence relatively small CO₂ recycles, with just 2 RGWS stages.

The person skilled in the art will readily understand that many modifications may be made without departing from the scope of the invention.

1-11. (canceled)

12. A method for producing syngas using a catalytic reverse water gas shift (RWGS) reaction, the method at least comprising the steps of:
(a) providing a feed stream comprising at least hydrogen (H₂) and carbon dioxide (CO₂);
(b) heating the feed stream in a first heat exchanger, thereby obtaining a first heated feed stream;
(c) introducing the first heated feed stream into a first RWGS reactor and subjecting it to a first catalytic RWGS reaction in the presence of a non-methanation promoting catalyst wherein the pressure as used in the first RWGS reactor is above 20 bara and wherein the temperature as used in the first RWGS reactor is from 450 to 600° C., thereby obtaining a first syngas containing stream,
wherein the first syngas containing stream comprises at most 1.0 vol. % methane (CH₄);
(d) cooling the first syngas containing stream in the first heat exchanger against the feed stream, thereby obtaining a first cooled syngas stream;
(e) separating the first cooled syngas stream in a first gas/liquid separator thereby obtaining a first water-enriched stream and a first water-depleted syngas stream;
(f) heating the first water-depleted syngas stream in a second heat exchanger thereby obtaining a heated first water-depleted syngas stream;
(g) introducing the heated first water-depleted syngas stream into a second RWGS reactor and subjecting it to a second catalytic RWGS reaction in the presence of a non-methanation promoting catalyst wherein the pressure as used in the second RWGS reactor is above 20 bara and wherein the temperature as used in the second RWGS reactor is from 450 to 600° C., thereby obtaining a second syngas containing stream;
(h) cooling the second syngas containing stream in the second heat exchanger against the first water-depleted syngas stream, thereby obtaining a second cooled syngas stream;
(i) separating the second cooled syngas stream in a second gas/liquid separator thereby obtaining a second water-enriched stream and a second water-depleted syngas stream;
(j) separating the second water-depleted syngas stream in a CO₂ removal unit thereby obtaining a CO₂-enriched stream and a CO₂-depleted syngas stream,
wherein the CO₂-depleted syngas stream has a hydrogen to carbon monoxide (H₂/CO) volume ratio in the range of from 1.5 to 2.5;
(k) combining the CO₂-enriched stream with the feed stream and/or the first water-depleted syngas stream;
wherein the temperature of the first syngas containing stream and the second syngas containing stream is kept below 600° C.; and
wherein the first and the second RWGS reactors each comprise a multi-tubular reactor heated by molten salt circulating around the tubes of the multi-tubular reactor.

13. The method according to claim 12, wherein the first heated feed stream comprises a hydrogen to carbon dioxide (H₂/CO₂) volume ratio of between 1.2 and 3.0.

14. The method according to claim 12, wherein the molten salt used for heating the multi-tubular reactors of the first and the second RWGS reactors is coming from a shared molten salt circulation system.

15. The method according to claim 12, wherein the pressure as used in the first and second RWGS reactors is from 20 to 200 bara.

16. The method according to claim 12, wherein the temperature as used in the first and second RWGS reactors is below 550° C.

17. The method according to claim 12, wherein the catalyst as used in the catalytic RWGS reaction in step (c) comprises cerium oxide, zirconium oxide or a combination thereof.

18. The method according to claim 12, wherein the first syngas containing stream comprises at most 0.1 vol. % methane.

19. The method according to claim 12, wherein the temperature of the second syngas containing stream is at most 20° C. higher than the temperature of the first syngas containing stream.

20. The method according to claim 12, wherein the heated first water-depleted syngas stream comprises a hydrogen to carbon dioxide (H₂/CO₂) volume ratio in the range of from 1.5 to 3.5.

21. The method according to claim 12, wherein at least a part of the CO₂-enriched stream is combined with at least the feed stream, thereby obtaining a combined stream.

22. The method according to claim 12, wherein the CO₂-depleted syngas stream comprises at most 10 vol. % CO₂.

23. The method according to claim 12, wherein the temperature of the first syngas containing stream and the second syngas containing stream is kept below 550° C.

24. The method according to claim 13, wherein the first heated feed stream comprises a hydrogen to carbon dioxide (H₂/CO₂) volume ratio above 1.5 and below 2.0.

25. The method according to claim 12, wherein the first syngas containing stream comprises at most 0.01 vol. % methane.

26. The method according to claim 12, wherein the temperature of the second syngas containing stream is at most 10° C. higher than the temperature of the first syngas containing stream.

27. The method according to claim 12, wherein the temperature of the second syngas containing stream is not higher than the temperature of the first syngas containing stream.

28. The method according to claim 12, wherein the heated first water-depleted syngas stream comprises a hydrogen to carbon dioxide (H₂/CO₂) volume ratio in the range of from 1.8 to 2.5.

29. The method according to claim 12, wherein the CO₂-depleted syngas stream comprises at most 5 vol. % CO₂.

30. The method according to claim 12, wherein the CO₂-depleted syngas stream comprises at most 2 vol. % CO₂.

31. An apparatus suitable for performing the method for producing syngas according to claim 12, the apparatus at least comprising:
a first heat exchanger for heat exchanging the feed stream against the first syngas containing stream obtained in the first RWGS reactor, to obtain a first heated feed stream and a first cooled syngas stream;
a first RWGS reactor for subjecting the first heated feed stream to a catalytic RWGS reaction to obtain a first syngas containing stream;
a first gas/liquid separator for separating the first cooled syngas stream to obtain a first water-enriched stream and a first water-depleted syngas stream;
a second heat exchanger for heat exchanging the first water-depleted syngas and the second syngas containing stream obtained in the second RWGS reactor, to obtain a heated first water-depleted syngas stream and a second cooled syngas product stream;
a second RWGS reactor for subjecting the heated first water-depleted syngas stream to a catalytic RWGS reaction to obtain a second syngas containing stream;
a second gas/liquid separator for separating the second cooled syngas stream to obtain a second water-enriched stream and a second water-depleted syngas stream;
a CO₂ removal unit for separating the second water-depleted syngas stream to obtain a CO₂-enriched stream and a CO₂-depleted syngas stream;
wherein the apparatus is configured to combine the CO₂-enriched stream obtained in the CO₂ removal unit with the feed stream and/or the first water-depleted syngas stream;
wherein the first and the second RWGS reactors each comprise a multi-tubular reactor that can be heated by molten salt circulating around the tubes of the multi-tubular reactor; and
wherein the apparatus further comprises a molten salt circulation system for heating the multi-tubular reactors of both the first and the second RWGS reactors.
